(19) United States
(12) Patent Application Publication
(10) Pub. No.: US 2024/0070401 A1
(43) Pub. Date: Feb. 29, 2024

(54) DETECTING OUT-OF-DOMAIN TEXT DATA IN DIALOG SYSTEMS USING ARTIFICIAL INTELLIGENCE

(71) Applicant: International Business Machines Corporation, Armonk, NY (US)

(72) Inventors: Cheng Qian, Markham (CA); Haode Qi, Cambridge, MA (US); Saloni Potdar, Cambridge, MA (US); Ladislav Kunc, Cambridge, MA (US)

(21) Appl. No.: 17/897,887

(22) Filed: Aug. 29, 2022

(51) Int. Cl. G06F 40/40; G06N 5/02

(52) U.S. Cl. CPC G06F 40/40; G06N 5/022

(57) ABSTRACT

Methods, systems, and computer program products for detecting out-of-domain text data in dialog systems using artificial intelligence techniques are provided herein. A computer-implemented method includes updating artificial intelligence techniques related to out-of-domain text data detection, the updating based on encoding training data and generating regularized representations of at least a portion of the encoded training data by combining the at least a portion of the encoded training data and at least one intent centroid associated with the updated artificial intelligence techniques; encoding input text data; computing out-of-domain scores, in connection with the at least one dialog system, for at least a portion of the encoded input text data by processing the at least a portion of encoded input data using at least a portion of the one or more updated artificial intelligence techniques; and performing one or more automated actions based on the computed out-of-domain scores.

### BACKGROUND

The present application generally relates to information technology and, more particularly, to language processing techniques. More specifically, end users of dialog systems often input queries that are incompatible with pre-configured domains of the systems, and in such situation, responses generated by the dialog systems may cause undesirable user experiences due to errors and/or inaccuracies.

### SUMMARY

In at least one embodiment, techniques for detecting out-of-domain text data in dialog systems using artificial intelligence techniques are provided. An example computer-implemented method includes updating one or more artificial intelligence techniques related to out-of-domain text data detection for at least one dialog system, the updating based at least in part on encoding one or more sets of training data and generating one or more regularized representations of at least a portion of the one or more encoded sets of training data by combining the at least a portion of the one or more encoded sets of training data and at least one intent centroid associated with the one or more updated artificial intelligence techniques. The method also includes encoding one or more items of input text data, and computing one or more out-of-domain scores, in connection with the at least one dialog system, for at least a portion of the one or more encoded items of input text data by processing the at least a portion of the one or more encoded items of input text data using at least a portion of the one or more updated artificial intelligence techniques. Additionally, the method includes performing one or more automated actions based at least in part on the one or more computed out-of-domain scores.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a system diagram according to an example embodiment of the invention;

FIG. 2 is a flow diagram illustrating techniques according to an example embodiment of the invention;

FIG. 3 is a flow diagram illustrating techniques according to an example embodiment of the invention; and

FIG. 4 is a diagram illustrating a computing environment in which at least one embodiment of the invention can be implemented.

### DETAILED DESCRIPTION

As described herein, at least one embodiment includes detecting out-of-domain text data (e.g., sentences) in dialog systems using artificial intelligence techniques (e.g., one or more nearest neighbor algorithms). Such an embodiment includes implementing improvements for artificial intelligence techniques such as nearest neighbor algorithms, wherein such improvements include, for example, effectively utilizing a limited amount of out-of-domain training examples, and regularizing nearest neighbor algorithms. As used herein, regularization refers to a type of machine learning technique that aims to solve a problem of overfitting (e.g., learning about the training data such that a machine learning model learns the noise in the dataset as well) by reducing excessive learning ability of machine learning models.

In the context of nearest neighbor algorithms, for example, one or more embodiments include implementing a compromise between storing all original representations in a nearest neighbor index, and storing the average representation of each intent class in a nearest neighbor index. Such an embodiment can include using a weighted average of the original representation and the average representation. By mixing the two representations, such an embodiment includes maintaining the learning ability of the nearest neighbor algorithm, and also providing a way to regularize that learning ability.

One or more embodiments includes implementing regularized representation of in-domain examples in at least one nearest neighbor search index. Such an embodiment can include storing at least one linear combination of feature vectors and at least one intent centroid in the nearest neighbor search index(es), which facilitates reduction of noise in the data. The training data (e.g., on-topic and off-topic sentences) are first encoded by one or more sentence encoders into at least one numerical vector representation. Such a step can be carried out, for example, to represent an actual sentence with a vector of numbers for machine learning models to consume. This is what is referred to herein as the feature vectors.

Additionally, the training examples to a task-oriented dialog system can come, for example, in the form of pairs of a sentence and a corresponding intent label, wherein the intent labels act as the target variable in a classification machine learning task. In one or more embodiments, an intent centroid can include the average of the feature vectors of sentences under one particular intent label.

Additionally, at least one embodiment includes protecting against one or more ill-defined intents, wherein, for example, a given mean vector would have a smaller modulus, and individual feature vectors effectively receive higher weights. In such an embodiment, weight factor determinations can be dynamic and adjusted based at least in part on metadata of the provided training examples. As used herein, “mean vector” is synonymous with “intent centroid,” as detailed above and herein. Also, as used herein, modulus refers to the length of a vector. For example, in the context of one or more embodiments, if the mean vector/intent centroid has as a small length value, it indicates that the feature vectors of sentences in this intent class are increasingly different. Therefore, such an intent class may not be sufficiently well-defined, as it contains sentences with potentially significantly different meanings. Accordingly, as detailed herein, at least one embodiment includes using a linear combination of individual feature vectors and mean vectors.

Accordingly, and as further detailed herein, one or more embodiments include implementing an extension, in the presence of out-of-domain training examples, to one or more nearest neighbor algorithms for anomaly detection in connection with dialog systems (e.g., wherein training data typically comprise in-domain examples). At least one such embodiment includes using the same sentence encoder to encode both in-domain and out-of-domain training examples, and also includes storing such encoded examples into at least one nearest neighbor search index. As used herein, a sentence encoder refers to a type of neural network used to convert sentences (in natural language) into vectors of numbers (e.g., such that machine learning algorithms can consume them). In one or more embodiments, encoding (e.g., producing vector representation) can include a feed forward process of such neural network sentence encoders, wherein input includes natural language sentences and output includes corresponding numerical vector representations.

Additionally, at runtime, one or more embodiments includes generating out-of-domain scores based at least in part on whether the corresponding nearest neighbor is in-domain or out-of-domain, as well as the distance to the nearest neighbor.

At least one embodiment of the present invention may provide a beneficial effect such as, for example, performing regularization on sentence representations of individual training examples, utilizing, for example, out-of-domain training examples provided by at least one chatbot designer for out-of-domain detection. Additionally, at least one embodiment of the present invention may provide a beneficial effect such as, for example, regularizing at least one nearest neighbor algorithm by storing a linear combination of individual sentence representation(s) and intent representation(s), wherein such an embodiment can include regularizing each of multiple individual sentence representations by moving the given representation towards its corresponding intent representation.

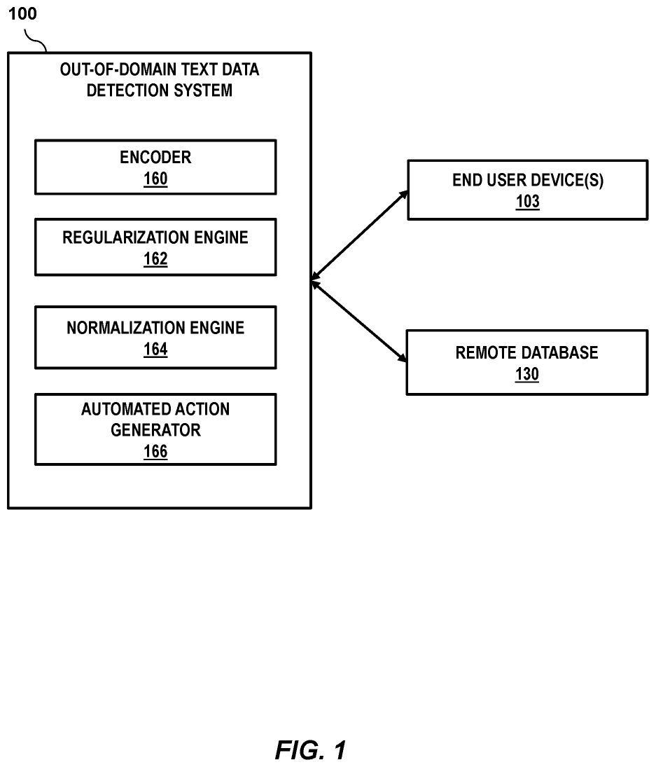

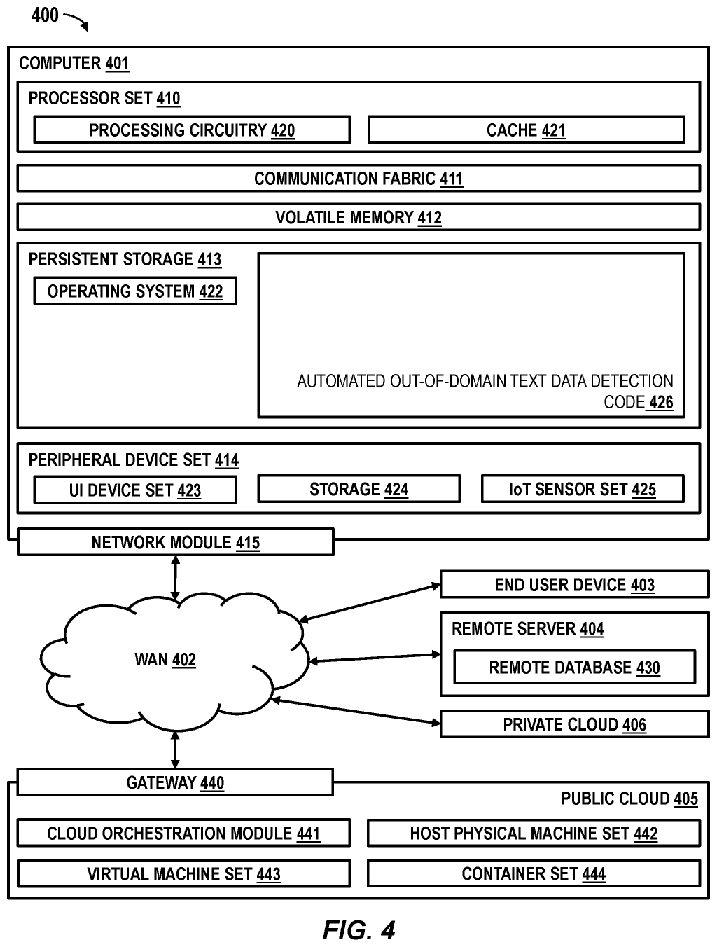

FIG. 1 is a system diagram according to an example embodiment of the invention. By way of illustration, FIG. 1 depicts out-of-domain text data detection system 100, which can encompass and/or comprise, for example, at least a portion of code such as included in block 426 (also referred to as automated out-of-domain text data detection code) as depicted in FIG. 4. As illustrated in FIG. 1, out-of-domain text data detection system 100 includes encoder 160, regularization engine 162, normalization engine 164, and automated action generator 166.

In one or more embodiments, encoder 160 can include at least one sentence encoder, and as detailed herein, encoder 160 encodes training data (e.g., text data), obtained from one or more end user devices 103 and/or remote database 130, into one or more feature vectors (e.g., one or more high dimensional vectors and/or embeddings). Such feature vectors can include and/or encompass numerical representations of at least portions of the training data. In one or more embodiments, calculating the specific numerical representations for each item of training data can include the following steps. First, sentences are passed through at least one sentence encoder. Second, regularization is performed for in-domain examples (e.g., by taking a linear combination of individual representations and the corresponding intent centroids). Third, the vectors can be normalized such that each vector has a length (modulus) of one.

As also depicted in FIG. 1, regularization engine 162 processes at least a portion of the feature vectors and generates at least one regularized representation thereof. For example, at least one embodiment includes implementing, via regularization engine 162, a regularization representation for at least one nearest neighbor algorithm in the context of out-of-domain text data detection for one or more dialog systems.

In such an embodiment, a regularized representation of in-domain examples in a given nearest neighbor search index can be determined via the following: α*FeatureVector_{i,j}+(1−α)*meanₖ(FeatureVector_{k,j}), 0<α≤1. Accordingly, for a given sentence i that belongs to and/or corresponds to intent j, FeatureVector_{i,j} is the vector representation of the sentence. Additionally, in such an algorithm, meanₖ(FeatureVector_{k,j}) is the average of the vector representations of intent j, and k represents the index of all training examples that belong to the same intent class as example i, which is intent j. Further, in such an algorithm, a is a tunable parameter and/or weight factor, and, in one or more embodiments, the algorithm can become more moderate and/or cautious when a is closer to zero.

Also, in at least one embodiment, storing individual sentence representations (e.g., in remote database 130) can improve precision but also introduce noise. As such, such an embodiment can include generating a linear combination of feature vectors and corresponding intent centroids to facilitate noise reduction. As used herein, a linear combination of two vectors (e.g., vector x and vector y) can be denoted as ax+by, wherein a and b are scalars, (also referred to as weights). As detailed, for example, in the formula in the previous paragraph, one or more embodiments can include implementing a linear combination of FeatureVector_{i,j} and meanₖ(FeatureVector_{k,j}), wherein their corresponding weights are α and 1−α, respectively.

As additionally noted herein, one or more embodiments include protecting against one or more ill-defined intents. In such an embodiment a mean vector (e.g., meanₖ(FeatureVector_{k,j})) would have a smaller modulus, and an individual feature vector (e.g., FeatureVector_{i,j}) would effectively get a higher weight a. In such an embodiment, weight factor α can be dynamically adjusted based at least in part on metadata of the provided training data. Also, in one or more embodiments, weight factor α can be set to be proportional to the log scale of the number of out-of-domain training examples that turns out to be generalized across multiple user datasets. For example, as noted above, the weight factor alpha can be dynamically adjusted (e.g., between 1 and 0). In at least one embodiment, if alpha is a linear function of the number of out-of-domain training examples provided (e.g., log scaled), the weight factor works well across datasets with different sizes.

Referring again to FIG. 1, after regularization is carried out by regularization engine 162, regularized representations (e.g., on-topic representations) are normalized using normalization engine 164, which can include generating a nearest neighbor index. In one or more embodiments, such normalization can include implementing one or more mathematic calculations that divide a vector by its length (modulus) such that the vector will have a length of one. As also detailed herein, a generated nearest neighbor index can be stored (e.g., in remote database 130) for use in one or more runtime executions.

In at least one embodiment, during runtime, the out-of-domain text data detection system 100 encodes, using encoder 160, user input (e.g., from end user device(s) 103) and computes the distance, using at least one nearest neighbor algorithm, between each input (runtime) sentence and one or more examples from the training data. Accordingly, in such an embodiment, a minimum distance value (e.g., a minimum cosine distance value) can be used if the nearest neighbor (to the given input sentence) is in-domain. Additionally or alternatively, if the nearest neighbor (to the given input sentence) is out-of-domain, an out-of-domain score can be generated, for example, using the following equation: β+(1−β)*(1−minimum distance value), wherein 0<β≤1, wherein this “minimum distance value” represents the distance (e.g., cosine distance) to the nearest neighbor (which here is out-of-domain). In one or more embodiments, an out-of-domain score can be used to discount an on-topic score and/or can be used as a standalone score to determine whether an example is off-topic based on a given threshold.

Referring again to FIG. 1, based at least in part on a nearest neighbor index, the determined minimum distance value(s), and/or the calculated out-of-domain score(s), one or more actions can be initiated and/or carried out via automated action generator 166 in connection with one or more dialog systems (which can be, for example connected to and/or resident on end user device(s) 103). By way merely of example, when an out-of-domain detection system predicts that a sentence is out-of-domain, one or more embodiments can include implementing actions such as responding to a chatbot end-user that the chatbot is not designed to handle such requests, asking, via the chatbot, the end-user for clarification on what their actual intents are, etc.

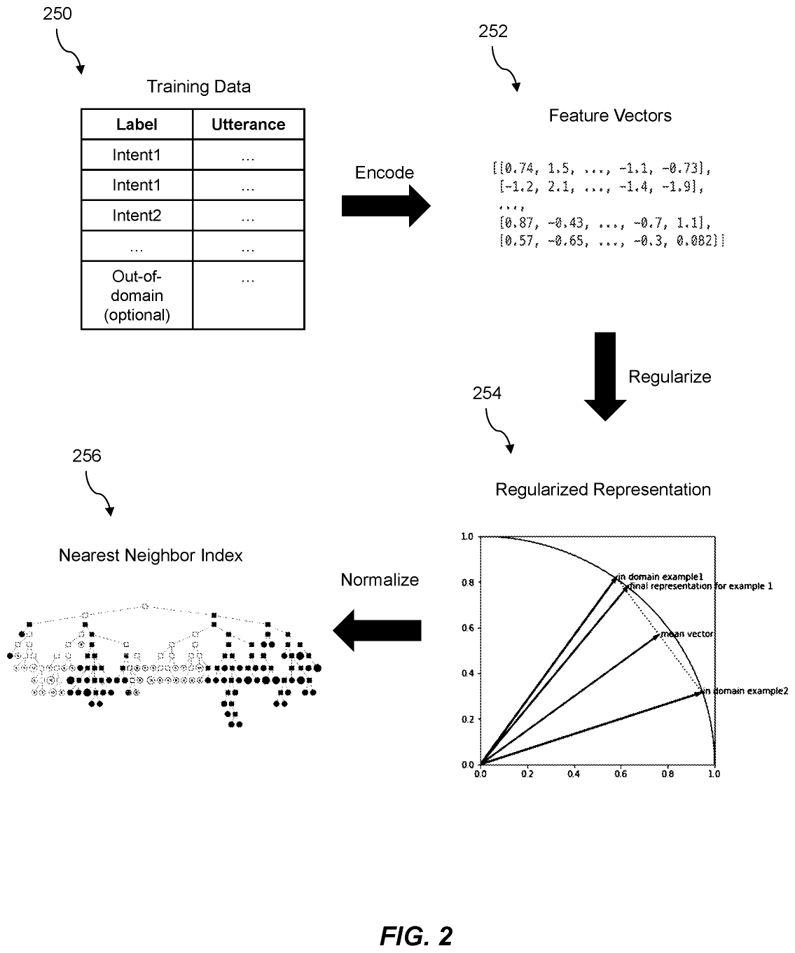

FIG. 2 is a flow diagram illustrating techniques according to an example embodiment of the invention. By way of illustration, FIG. 2 depicts training data 250, which can include pairs of intents and utterances, along with, optionally, out-of-domain data with corresponding utterances, which are converted to feature vectors 252 using one or more sentence encoders. Such training data 250 can be provided, for example, by the designer(s) of a dialog-oriented system (e.g., a chatbot). Also, because out-of-domain training data can be difficult to obtain, one or more embodiments includes not relying on the existing of out-of-domain training data (hence being labeled as optional in FIG. 2).

Additionally, in connection with converting training data 250 to feature vectors 252, one or more embodiments can include implementing at least one equation pertaining to vector shape such as, for example, Shape=(N_{in-domain}+N_{OOD})*Dim, wherein N_{in-domain} refers to the number of in-domain examples in the training data, N_{OOD} refers to the number of out-of-domain (OOD) training examples in the training data, and Dim refers to the dimension of the output representation of a sentence encoder. In such an embodiment, one or more sentence encoders encode each sentence into one vector; therefore, in such an embodiment, there will be the same number of output feature vectors as there are sentences in the training data (e.g., the number of on-topic examples+the number of off-topic examples). Also, in one or more embodiments, regardless of how long a sentence is, the length of the output vector from a particular sentence encoder is fixed, and this length is represented by Dim (in the above-noted equation).

As also depicted in FIG. 2, at least a portion of the feature vectors 252 (e.g., feature vectors related to on-topic examples) can be regularized (that is, generated into at least one regularized representation 254) using the centroid(s) of each intent. After regularization, both on-topic and off-topic representations will be normalized, generating a nearest neighbor index 256, which can then be stored for runtime. As used herein, a nearest neighbor index refers to a data structure for implementing one or more nearest neighbor algorithms. Additionally, as detailed herein, a nearest neighbor algorithm includes a machine learning algorithm that can be applied, for example, to classification and anomaly detection tasks. Such a nearest neighbor algorithm stores training data in a nearest neighbor index (of which there are multiple possible implementations) and can use the nearest neighbor index, for example, like a look-up table to search for the closest training example given an example at runtime.

In the context of out-of-domain detection, one or more embodiments include using at least one nearest neighbor algorithm to determine how relevant (e.g., in-domain) a sentence is by searching for its nearest neighbor and determining the distance thereto. The training data to the nearest neighbor algorithm can include, for example, some form of numeric representation of input training sentences. At runtime, in such an embodiment, the nearest neighbor index receives the numeric representation of a sentence and returns the nearest neighbor and the distance thereto.

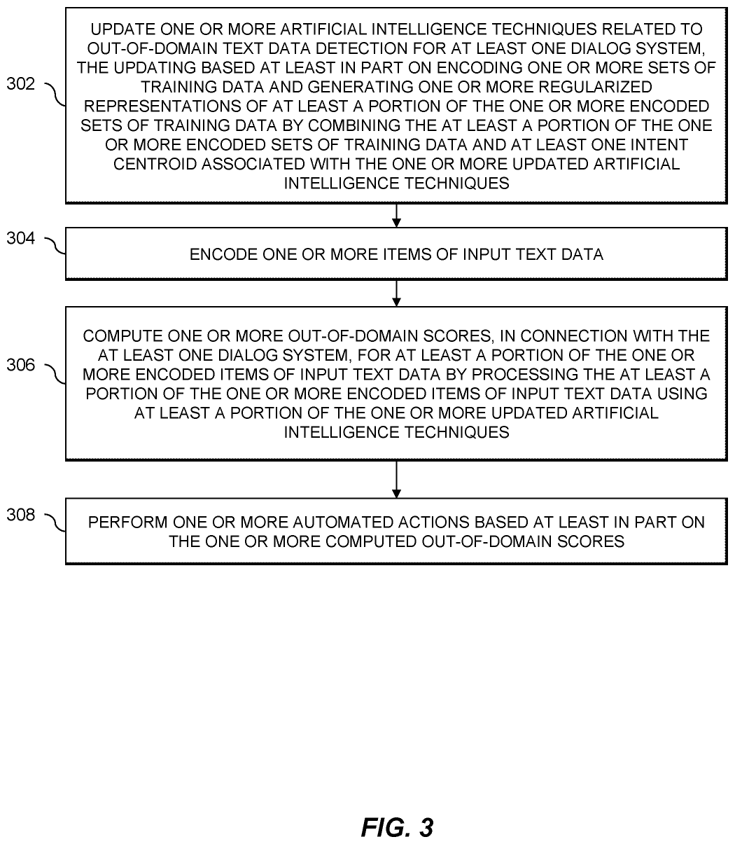

FIG. 3 is a flow diagram illustrating techniques according to an embodiment of the present invention. Step 302 includes updating one or more artificial intelligence techniques related to out-of-domain text data detection for at least one dialog system, the updating based at least in part on encoding one or more sets of training data and generating one or more regularized representations of at least a portion of the one or more encoded sets of training data by combining (e.g., implementing at least one linear combination of) the at least a portion of the one or more encoded sets of training data and at least one intent centroid associated with the one or more updated artificial intelligence techniques. In at least one embodiment, generating one or more regularized representations of at least a portion of the one or more encoded sets of training data can include implementing at least one weight factor, wherein the at least one weight factor is based at least in part on metadata associated with the one or more sets of training data. Also, in at least one embodiment, updating one or more artificial intelligence techniques includes updating one or more nearest neighbor index related to out-of-domain text data detection for the at least one dialog system.

Step 304 includes encoding one or more items of input text data. In one or more embodiments, encoding one or more sets of training data includes encoding the one or more sets of training data into one or more vector representations using one or more sentence encoders, and encoding one or more items of input text data includes encoding the one or more items of input text data into one or more vector representations using one or more sentence encoders (e.g., the same one or more sentence encoders).

Step 306 includes computing one or more out-of-domain scores, in connection with the at least one dialog system, for at least a portion of the one or more encoded items of input text data by processing the at least a portion of the one or more encoded items of input text data using at least a portion of the one or more updated artificial intelligence techniques. In at least one embodiment, computing one or more out-of-domain scores includes computing one or more minimum distance scores (e.g., one or more minimum cosine distance scores), using at least one nearest neighbor algorithm, between the at least a portion of the one or more encoded items of input text data and at least a portion of the one or more sets of encoded training data. In such an embodiment, computing one or more out-of-domain scores can also include determining, using the at least one nearest neighbor algorithm, whether a nearest neighbor among the at least a portion of the one or more sets of encoded training data is in-domain or out-of-domain.

Step 308 includes performing one or more automated actions based at least in part on the one or more computed out-of-domain scores. In one or more embodiments, performing one or more automated actions includes automatically detecting, using the one or more computed out-of-domain scores, out-of-domain text data in one or more input queries associated with the at least one dialog system. Additionally or alternatively, performing one or more automated actions can include automatically training at least a portion of the one or more updated artificial intelligence techniques based at least in part on feedback related to the one or more computed out-of-domain scores.

Also, in at least one embodiment, software implementing the techniques depicted in FIG. 3 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 of FIG. 4 contains an example of an environment for the execution of at least some of the computer code involved in performing the inventive methods (e.g., via block 426), such as generating nearest neighbor models (also referred to herein as nearest neighbor indexes) for improved automated out-of-domain text data detection. In addition to block 426, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 426, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 426 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type RAM or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a ROM, but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 426 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
updating one or more artificial intelligence techniques related to out-of-domain text data detection for at least one dialog system, the updating based at least in part on encoding one or more sets of training data and generating one or more regularized representations of at least a portion of the one or more encoded sets of training data by combining the at least a portion of the one or more encoded sets of training data and at least one intent centroid associated with the one or more updated artificial intelligence techniques;
encoding one or more items of input text data;
computing one or more out-of-domain scores, in connection with the at least one dialog system, for at least a portion of the one or more encoded items of input text data by processing the at least a portion of the one or more encoded items of input text data using at least a portion of the one or more updated artificial intelligence techniques; and
performing one or more automated actions based at least in part on the one or more computed out-of-domain scores;
wherein the method is carried out by at least one computing device.

2. The computer-implemented method of claim 1, wherein performing one or more automated actions comprises automatically detecting, using the one or more computed out-of-domain scores, out-of-domain text data in one or more input queries associated with the at least one dialog system.

3. The computer-implemented method of claim 1, wherein generating one or more regularized representations of at least a portion of the one or more encoded sets of training data comprises implementing at least one weight factor, wherein the at least one weight factor is based at least in part on metadata associated with the one or more sets of training data.

4. The computer-implemented method of claim 1, wherein computing one or more out-of-domain scores comprises computing one or more minimum distance scores, using at least one nearest neighbor algorithm, between the at least a portion of the one or more encoded items of input text data and at least a portion of the one or more sets of encoded training data.

5. The computer-implemented method of claim 4, wherein computing one or more out-of-domain scores further comprises determining, using the at least one nearest neighbor algorithm, whether a nearest neighbor among the at least a portion of the one or more sets of encoded training data is in-domain or out-of-domain.

6. The computer-implemented method of claim 4, wherein computing one or more minimum distance scores comprises computing one or more minimum cosine distance scores.

7. The computer-implemented method of claim 1, wherein updating one or more artificial intelligence techniques comprises updating one or more nearest neighbor index related to out-of-domain text data detection for the at least one dialog system.

8. The computer-implemented method of claim 1, wherein encoding one or more sets of training data comprises encoding the one or more sets of training data into one or more vector representations using one or more sentence encoders.

9. The computer-implemented method of claim 1, wherein encoding one or more items of input text data comprises encoding the one or more items of input text data into one or more vector representations using one or more sentence encoders.

10. The computer-implemented method of claim 1, wherein performing one or more automated actions comprises automatically training at least a portion of the one or more updated artificial intelligence techniques based at least in part on feedback related to the one or more computed out-of-domain scores.

11. The computer-implemented method of claim 1, wherein software implementing the method is provided as a service in a cloud environment.

12. A computer program product comprising a computer readable storage medium having program instructions embodied therewith, the program instructions executable by a computing device to cause the computing device to:
update one or more artificial intelligence techniques related to out-of-domain text data detection for at least one dialog system, the updating based at least in part on encoding one or more sets of training data and generating one or more regularized representations of at least a portion of the one or more encoded sets of training data by combining the at least a portion of the one or more encoded sets of training data and at least one intent centroid associated with the one or more updated artificial intelligence techniques;
encode one or more items of input text data;
compute one or more out-of-domain scores, in connection with the at least one dialog system, for at least a portion of the one or more encoded items of input text data by processing the at least a portion of the one or more encoded items of input text data using at least a portion of the one or more updated artificial intelligence techniques; and
perform one or more automated actions based at least in part on the one or more computed out-of-domain scores.

13. The computer program product of claim 12, wherein performing one or more automated actions comprises automatically detecting, using the one or more computed out-of-domain scores, out-of-domain text data in one or more input queries associated with the at least one dialog system.

14. The computer program product of claim 12, wherein computing one or more out-of-domain scores comprises computing one or more minimum distance scores, using at least one nearest neighbor algorithm, between the at least a portion of the one or more encoded items of input text data and at least a portion of the one or more sets of encoded training data.

15. The computer program product of claim 14, wherein computing one or more out-of-domain scores further comprises determining, using the at least one nearest neighbor algorithm, whether a nearest neighbor among the at least a portion of the one or more sets of encoded training data is in-domain or out-of-domain.

16. The computer program product of claim 12, wherein updating one or more artificial intelligence techniques comprises updating one or more nearest neighbor index related to out-of-domain text data detection for the at least one dialog system.

17. A system comprising:
a memory configured to store program instructions; and
a processor operatively coupled to the memory to execute the program instructions to:
update one or more artificial intelligence techniques related to out-of-domain text data detection for at least one dialog system, the updating based at least in part on encoding one or more sets of training data and generating one or more regularized representations of at least a portion of the one or more encoded sets of training data by combining the at least a portion of the one or more encoded sets of training data and at least one intent centroid associated with the one or more updated artificial intelligence techniques;
encode one or more items of input text data;
compute one or more out-of-domain scores, in connection with the at least one dialog system, for at least a portion of the one or more encoded items of input text data by processing the at least a portion of the one or more encoded items of input text data using at least a portion of the one or more updated artificial intelligence techniques; and
perform one or more automated actions based at least in part on the one or more computed out-of-domain scores.

18. The system of claim 17, wherein performing one or more automated actions comprises automatically detecting, using the one or more computed out-of-domain scores, out-of-domain text data in one or more input queries associated with the at least one dialog system.

19. The system of claim 17, wherein computing one or more out-of-domain scores comprises computing one or more minimum distance scores, using at least one nearest neighbor algorithm, between the at least a portion of the one or more encoded items of input text data and at least a portion of the one or more sets of encoded training data.

20. The system of claim 19, wherein computing one or more out-of-domain scores further comprises determining, using the at least one nearest neighbor algorithm, whether a nearest neighbor among the at least a portion of the one or more sets of encoded training data is in-domain or out-of-domain.
